(19) United States
(12) Patent Application Publication
(10) Pub. No.: US 2013/0100854 A1
(43) Pub. Date: Apr. 25, 2013

(54) VPLS OVER MULTI-CHASSIS TRUNK

(71) Applicant: BROCADE COMMUNICATIONS SYSTEMS, INC., San Jose, CA (US)

(72) Inventors: Srinivas Tatikonda, Fremont, CA (US); Rahul Vir, Cupertino, CA (US); Eswara S.P. Chinthalapati, San Jose, CA (US); Vivek Agarwal, San Jose, CA (US); Lok Yan Hui, Milpitas, CA (US)

(73) Assignee: BROCADE COMMUNICATIONS SYSTEMS, INC., San Jose, CA (US)

(21) Appl. No.: 13/656,438

(22) Filed: Oct. 19, 2012

Related U.S. Application Data
(60) Provisional application No. 61/550,285, filed on Oct. 21, 2011.

(51) Int. Cl. H04L 12/28

(52) U.S. Cl. 370/254

(57) ABSTRACT

One embodiment of the present invention provides a switch. The switch includes a link aggregation database, an arbitration module, a packet processor, and a logical connection management module. The link aggregation database stores information regarding a plurality of switches participating in a multi-chassis trunk. The plurality of switches includes the switch as well. The arbitration module selects a switch of the plurality of switches as an active switch based on the information in the link aggregation database. The packet processor constructs a packet for a remote switch forwardable via a logical connection. The logical connection management module operates in conjunction with the packet processor and constructs a message containing instructions for creating a second logical connection to a second switch of the plurality of switches.

### RELATED APPLICATIONS

This application claims the benefit of U.S. Provisional Application No. 61/550,285, Attorney Docket Number BRCD-3120.0.1.US.PSP, titled “Supporting L2 VPN/VPLS Functionality with Active-Active MCT Attachment Circuits/End-Points,” by inventors Srinivas Tatikonda, Rahul Vir, Eswara S. P. Chinthalapati, Vivek Agarwal, and Lok Yan Hui, filed 21 Oct. 2011, the disclosure of which is incorporated by reference herein.

The present disclosure is related to U.S. patent application Ser. No. 12/730,749, (Attorney Docket Number BRCD-3009.1.US.NP), titled “Method and System for Extending Routing Domain to Non-Routing End Stations,” by inventors Pankaj K. Jha and Mitri Halabi, filed 24 Mar. 2010, the disclosure of which is incorporated by reference herein.

### BACKGROUND

1. Field

The present disclosure relates to network management. More specifically, the present disclosure relates to a method and system for efficiently implementing virtual private local area network (LAN) service (VPLS) over multi-chassis trunks.

2. Related Art

The exponential growth of the Internet has made it a popular delivery medium for multimedia applications, such as video on demand and television. Such applications have brought with them an increasing demand for bandwidth. As a result, equipment vendors race to build larger and faster switches with versatile capabilities, such as multicasting, to move more traffic efficiently. However, the size of a switch cannot grow infinitely. It is limited by physical space, power consumption, and design complexity, to name a few factors. Furthermore, switches with higher capability are usually more complex and expensive. More importantly, because an overly large and complex system often does not provide economy of scale, simply increasing the size and capability of a switch may prove economically unviable due to the increased per-port cost.

As more time-critical applications are being implemented in data communication networks, high-availability operation is becoming progressively more important as a value proposition for network architects. It is often desirable to aggregate links to multiple switches to operate as a single logical link (referred to as a multi-chassis trunk or an MCT) to facilitate load balancing among the multiple switches while providing redundancy to ensure that a device failure or link failure would not affect the data flow. The switches participating in a multi-chassis trunk are referred to as partner switches.

Currently, such multi-chassis trunks in a network have not been able to take advantage of the distributed interconnection available for a typical virtual private local area network (LAN) service (VPLS). VPLS provides a virtual private network (VPN) between switches located in remote sites. VPLS allows geographically distributed sites to share a layer-2 broadcast domain. Individual switches (can be referred to as provider edge (PE) nodes) in a local network are equipped to manage VPLS traffic but are constrained while operating in conjunction with each other for providing a multi-chassis trunk. A PE node participating in a multi-chassis trunk can be referred to as a partner PE node. An end device coupled to a multi-chassis trunk typically sends traffic to multiple switches. A respective recipient switch then sends the traffic to a remote site using VPLS. As a result, the switches in the remote site receive traffic from the same end device via multiple switches and observe continuous end device movement. Such movement hinders the performance of VPLS.

While multi-chassis trunk brings many desirable features to networks, some issues remain unsolved for VPLS implementations.

### SUMMARY

One embodiment of the present invention provides a switch. The switch includes a link aggregation database, an arbitration module, a packet processor, and a logical connection management module. The link aggregation database stores information regarding a plurality of switches participating in a multi-chassis trunk. The plurality of switches includes the switch as well. The arbitration module selects a switch of the plurality of switches as an active switch based on the information in the link aggregation database. The packet processor constructs a packet for a remote switch forwardable via a logical connection. The logical connection management module operates in conjunction with the packet processor and constructs a message containing instructions for creating a second logical connection to a second switch of the plurality of switches.

In a variation on this embodiment, a respective logical connection is a pseudo-wire associated with a virtual private local area network (LAN) service (VPLS) instance, wherein the pseudo-wire represents a logical link in a virtual private network (VPN).

In a further variation on this embodiment, the pseudo-wire is a Multiprotocol Label Switching (MPLS) connection.

In a further variation on this embodiment, the logical connection management module associates the second logical connection with a second VPLS instance.

In a variation on this embodiment, the logical connection management module precludes the switch from learning a layer-2 address of a packet received from the second logical connection.

In a variation on this embodiment, the packet for the remote switch includes information indicating whether the switch is the active switch.

In a variation on this embodiment, the arbitration module selects the switch as a standby switch if the second switch is selected as the active switch, and precludes the packet processor from constructing a packet forwardable via a logical connection for the remote switch.

In a further variation on this embodiment, the packet processor constructs a packet encapsulating a frame received from a local port of the switch, wherein the packet is for the second switch and forwardable via the second logical connection.

In a further variation on this embodiment, the packet processor discards a packet forwardable via a logical connection received from the remote switch, and the logical connection management module precludes the switch from learning a layer-2 address of the packet.

In a further variation on this embodiment, the packet processor extracts from a packet one or more layer-2 addresses learned by the second switch.

### BRIEF DESCRIPTION OF THE FIGURES

FIG. 1A illustrates an exemplary virtual private network with a multi-chassis trunk, in accordance with an embodiment of the present invention.

FIG. 1B illustrates an exemplary virtual private network with redundancy support and a multi-chassis trunk, in accordance with an embodiment of the present invention.

FIG. 2 presents a flowchart illustrating the process of a partner PE node establishing logical connections, in accordance with an embodiment of the present invention.

FIG. 3A presents a flowchart illustrating the process of a PE node learning the layer-2 address of a received frame, in accordance with an embodiment of the present invention.

FIG. 3B presents a flowchart illustrating the process of a PE node learning layer-2 addresses from a partner PE node, in accordance with an embodiment of the present invention.

FIG. 4A presents a flowchart illustrating the process of a partner PE node forwarding a unicast data frame, in accordance with an embodiment of the present invention.

FIG. 4B presents a flowchart illustrating the process of a partner PE node forwarding a multi-destination frame, in accordance with an embodiment of the present invention.

FIG. 5 illustrates exemplary failure scenarios in a virtual private network with a multi-chassis trunk, in accordance with an embodiment of the present invention.

FIG. 6A presents a flowchart illustrating the recovery process of a partner PE node from a partner node failure, in accordance with an embodiment of the present invention.

FIG. 6B presents a flowchart illustrating the recovery process of a partner PE node from a link failure, in accordance with an embodiment of the present invention.

FIG. 7 illustrates an exemplary architecture of a switch, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

### Overview

In embodiments of the present invention, the problem of implementing virtual private LAN service (VPLS) over a multi-chassis trunk is solved by selecting an active forwarding switch from the switches participating in the multi-chassis trunk. A multi-chassis trunk is established when an end device couples to a plurality of networking devices (e.g., switches) using a link aggregation. The end device coupled to a multi-chassis trunk can be referred to as a multi-homed end device. The aggregated links operates as a single logical link to facilitate load balancing among the multiple switches while providing redundancy. The switches participating in a multi-chassis trunk (referred to as partner switches) synchronize their configuration information with each other. Based on the synchronized information, partner switches are configured to appear as a single logical switch to the end device.

However, partner switches typically operate as two separate switches in a virtual private network for a VPLS instance. Network devices (e.g., switches and routers) that are capable of originate and terminate connection for a VPLS instance can be referred to as provider edge (PE) nodes. A PE node typically sends traffic to another PE node in a remote network site. The PE node in the remote network site can be referred to as a remote PE node. End devices coupled to PE nodes can be referred to as customer edge (CE) nodes. Note that the same physical networking device can operate as a regular switch and a PE node. The networking device can operate as a switch while communicating with a CE node and as a PE node while communicating with another PE node. Hence, a partner switch capable of originating and terminating connections for a VPLS instance can be considered as PE nodes as well. These partner switches operate as a single logical switch for a multi-homed CE node while operating as two separate PE nodes for a respective VPLS instance. Partner switches operating as PE nodes and participating in a multi-chassis trunk can be referred to as partner PE nodes.

A multi-homed CE node forwards traffic to all partner PE nodes. As a result, a respective partner PE node forwards that traffic to PE nodes in a remote site. The remote PE nodes receive traffic coming from the same CE node via two different PE nodes. When a respective remote PE node independently receives such traffic from multiple PE nodes, the remote PE node considers that the CE node is moving between the PE nodes. In other words, the remote PE node perceives that the CE node is continuously decoupling from one partner PE node and coupling to another partner PE node. The remote PE node thus continuously updates the local layer-2 forwarding table. Such movement hinders self-learning-based layer-2 switching (e.g., Ethernet switching), which is essential for VPLS to facilitate a virtual private network.

To solve this problem, partner PE nodes select a single active PE node which forwards traffic to remote PE nodes via logical connections. Other partner switches operates as standby PE nodes that preclude from forwarding traffic to remote PE nodes. A respective partner PE node can identify the active switch from the locally stored information regarding the partner PE nodes. When a standby PE node receives any traffic from the local ports, the standby PE node forwards the traffic to the active PE node. To exchange traffic, the partner PE nodes create a separate VPLS instance and interconnect each other via logical connections. In some embodiments, a logical connection is a VPLS pseudo-wire created using Multiprotocol Label Switching (MPLS) connections. A respective logical connection between two partner PE nodes can be referred to as a spoke. Upon receiving traffic from a standby PE node via a spoke, the active PE node forwards the frame to the remote PE nodes. Note that the VPLS instances in partner PE nodes are aware of the multi-chassis trunk. As a result, a respective partner PE node can distinguish the multi-homed CE node from other local CE nodes. However, the corresponding VPLS instance in the remote PE nodes is not aware of the multi-chassis trunk.

Because the remote PE nodes receive traffic from the multi-homed CE node only via the active PE node, the remote PE nodes consider the CE node to be coupled to the active PE node. A respective partner PE node establishes logical connections to the same remote PE nodes. As a result, all partner PE nodes have identical peering with remote PE nodes. If the active PE node incurs a failure, one of the standby partner PE nodes becomes the active PE node and starts forwarding traffic to the remote PE nodes. Hence, a multi-homed CE node can actively communicate with all partner PE nodes while only one of the partner PE nodes actively communicates with a remote PE node. In this way, embodiments of the present invention implement multi-chassis trunk with VPLS support.

In some embodiments, the partner PE nodes are member switches of a fabric switch. An end device can be coupled to the fabric switch via a multi-chassis trunk. A fabric switch in the network can be an Ethernet fabric switch or a virtual cluster switch (VCS). In an Ethernet fabric switch, any number of switches coupled in an arbitrary topology may logically operate as a single switch. Any new switch may join or leave the fabric switch in “plug-and-play” mode without any manual configuration. In some embodiments, a respective switch in the Ethernet fabric switch is a Transparent Interconnection of Lots of Links (TRILL) routing bridge (RBridge). A fabric switch appears as a single logical switch to the end device.

Although the present disclosure is presented using examples based on VPLS, embodiments of the present invention are not limited to VPLS. Embodiments of the present invention are relevant to any method that facilitate a virtual private network. In this disclosure, the term “VPLS” is used in a generic sense, and can refer to any network interconnection virtualization technique implemented in any networking layer, sub-layer, or a combination of networking layers.

In this disclosure, the term “PE node” is used in a generic sense and can refer to any network device participating in a virtual private network. A PE node can refer to any networking device capable of establishing and maintaining a logical connection to another remote networking device. The term “logical connection” can refer to a virtual link which spans across one or more physical links and appears as a single logical link between the end points of the logical connection. Examples of a logical connection include, but are not limited to, a VPLS pseudo-wire, and an MPLS or Generalized MPLS (GMPLS) connection.

In this disclosure, the term “end device” can refer to a host machine, a conventional switch, or any other type of networking device. An end device can be coupled to other switches or hosts further away from a network. An end device can also be an aggregation point for a number of switches to enter the network. The term “CE node” can refer to a host machine, a conventional switch, or any other type of networking device coupled to a PE node via one or more physical links. The terms “end device” and “CE node” are interchangeably in this disclosure.

The term “frame” refers to a group of bits that can be transported together across a network. “Frame” should not be interpreted as limiting embodiments of the present invention to layer-2 networks. “Frame” can be replaced by other terminologies referring to a group of bits, such as “packet,” “cell,” or “datagram.”

The term “switch” is used in a generic sense, and it can refer to any standalone or fabric switch operating in any network layer. “Switch” should not be interpreted as limiting embodiments of the present invention to layer-2 networks. Any device that can forward traffic to an end device can refer to be referred to as a “switch.” Examples of a “network device” include, but not limited to, a layer-2 switch, a layer-3 router, or a TRILL RBridge. In this disclosure, the terms “switch” and “PE node” are used interchangeably. The same physical device can be referred to as a switch and a PE node.

The term “Ethernet fabric switch” or “VCS” refers to a number of interconnected physical switches which form a single, scalable logical switch. In a fabric switch, any number of switches can be connected in an arbitrary topology and the entire group of switches functions together as one single, logical switch. This feature makes it possible to use many smaller, inexpensive switches to construct a large fabric switch, which can be viewed as a single logical switch externally.

### Network Architecture

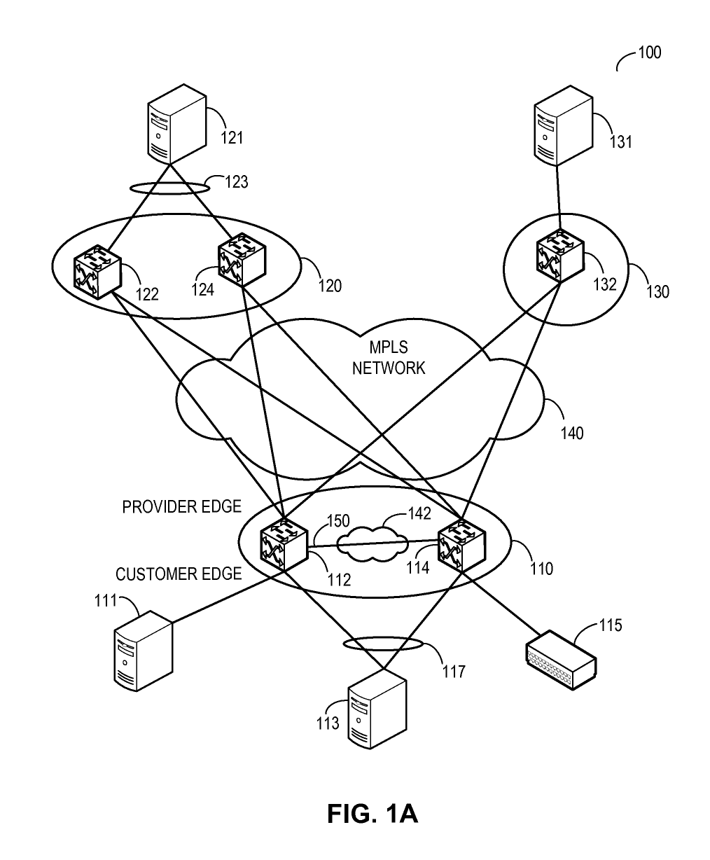

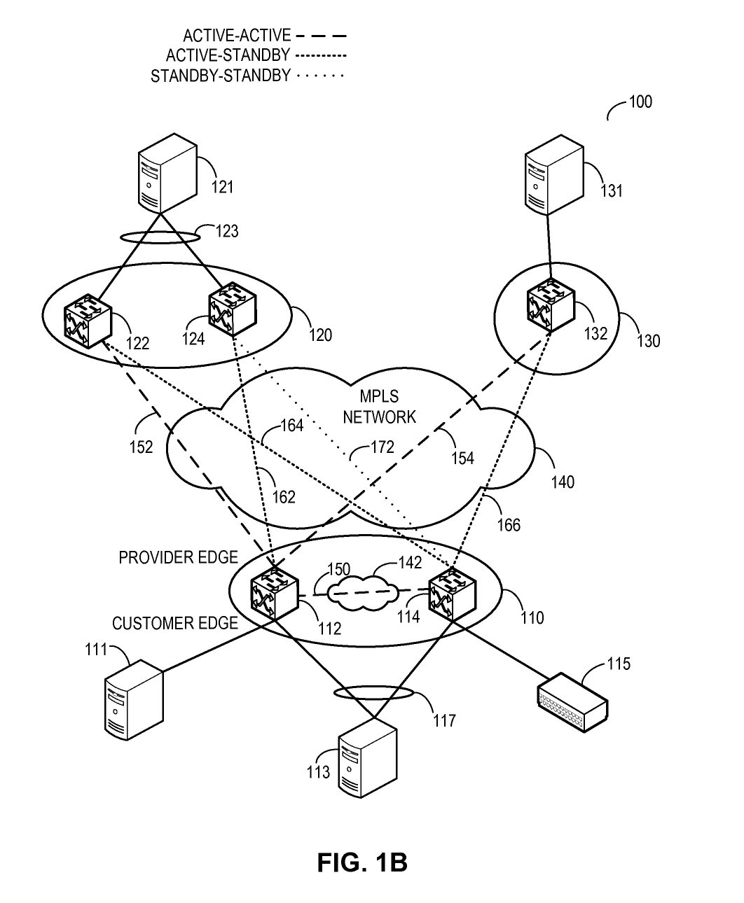

FIG. 1A illustrates an exemplary virtual private network with a multi-chassis trunk, in accordance with an embodiment of the present invention. As illustrated in FIG. 1A, a virtual private network 100 includes network sites 110, 120, and 130, interconnected via network 140. In some embodiments, network 140 is an MPLS network. Site 110 includes PE nodes 112 and 114. Multi-homed CE node 113 is coupled to partner PE nodes 112 and 114 via multi-chassis trunk 117. Because multi-chassis trunk 117 logically aggregates the links between CE node 113 and PE nodes 112 and 114, multi-chassis trunk 117 can be referred to as a link aggregation as well. PE nodes 112 and 114 can be coupled to each other via one or more physical links CE nodes 111 and 115 are coupled to PE nodes 112 and 114, respectively, via one or more physical links In this example, CE node 115 is a layer-2 switch. Site 120 includes CE node 121 coupled to PE nodes 122 and 124 via one or more physical links. Site 130 includes CE node 131 coupled to PE node 132 via one or more physical links. In some embodiments, partner PE nodes 112 and 114 have a separate identifier (e.g., an Internet Protocol (IP) address), respectively. These identifiers individually identify partner PE nodes 112 and 114 in network 140.

During operation, PE nodes 112 and 114 recognize each other as partner PE nodes. A PE node can recognize a partner PE node from local information preconfigured by a network administrator. PE nodes 112 and 114 establish a point-to-point connection among them and synchronize configuration information. Configuration information can include, but are not limited to, a PE node identifier (e.g., an IP address), a virtual circuit identifier or a VCID, a virtual circuit mode, and the layer-2 forwarding table size. PE nodes 112 and 114 can store the configuration information in a local link-aggregation database. In some embodiments, PE node 112 constructs a control message requesting to establish a separate logical connection and sends the control message to partner PE node 114. In the same way, PE node 114 also creates a control message and sends the message to partner PE node 112. By exchanging these control messages, PE nodes 112 and 114 create a separate network 142 and interconnect each other via logical connection 150. Logical connection 150 can be an MPLS-based VPLS pseudo-wire. A logical connection between two partner PE nodes, such as logical connection 150, can be referred to as a spoke.

Partner PE nodes 112 and 114 then select PE node 112 as the active node and PE node 114 as a standby node. As an active node, PE node 112 forwards traffic to remote PE nodes. On the other hand, as a standby node, PE node 114 does not forward traffic to a remote PE node and forwards locally received traffic to active PE node 112 via spoke 150. PE nodes 112 and 114 can exchange control messages via spoke 150 to select the active node. PE nodes 112 and 114 can use a distributed protocol to select the active node. In some embodiments, PE nodes 112 and 114 exchange their respective identifiers with each other and select the PE node with the lowest (or the highest) identifier value as the active node. Note that both partner PE nodes 112 and 114 can identify the active PE node from the locally stored information (e.g., PE node identifier) regarding the partner PE nodes. For example, PE node 114 can select and recognize PE node 112 as the active PE node based on the locally stored information regarding PE node 112.

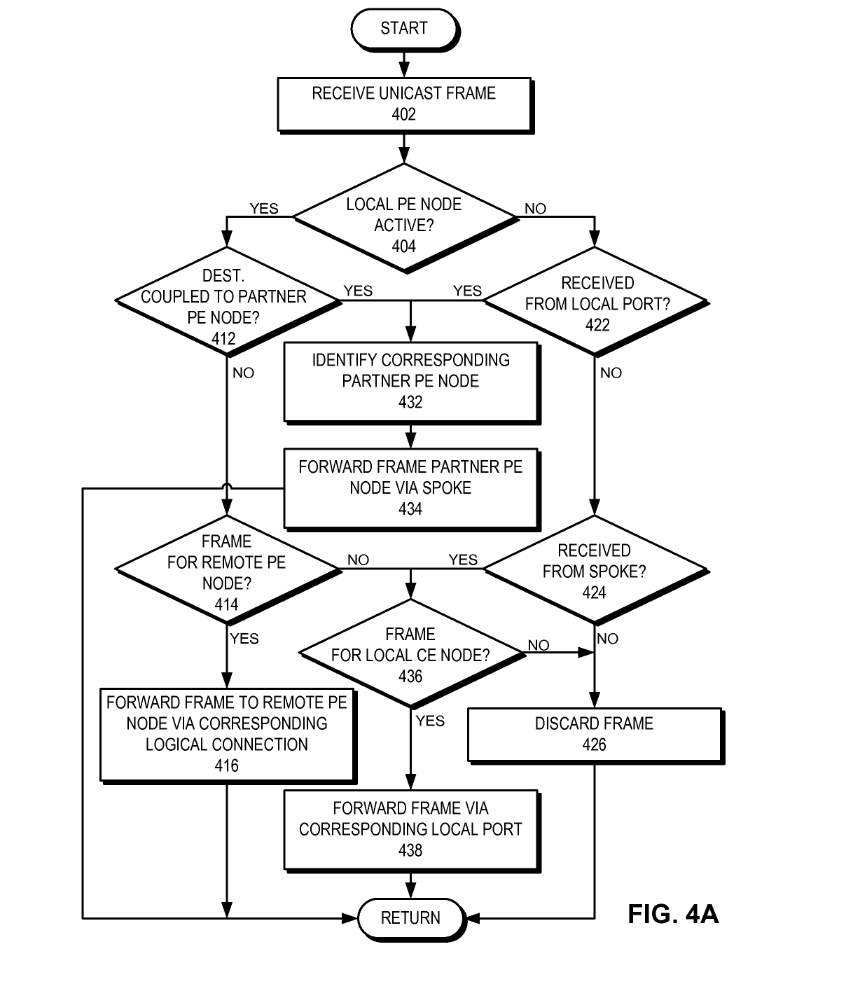

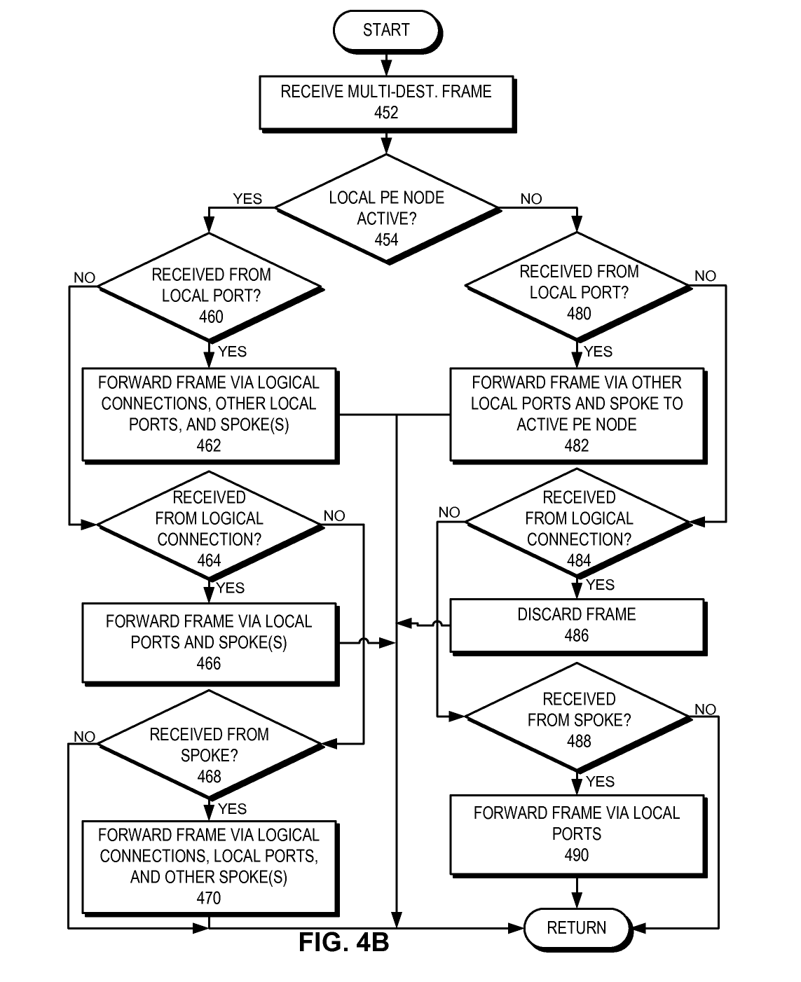

Note that network 142 is a separate network than network 140. Network 142 is established after PE nodes 112 and 114 exchange information to recognize each other as partner PE nodes. In some embodiments, PE nodes 112 and 114 use point-to-point Compression Control Protocol (CCP) to exchange information. Spoke 150 allows PE nodes 112 and 114 to send control messages for signaling each other even without any activity a local CE node. For example, PE node 112 can send a control message to PE node 114 even when CE nodes 111 and 113 are inactive. Messages sent via spoke 150 can have a different forwarding strategy than the other logical connections in network 140, as described in conjunction with FIGS. 4A and 4B. To avoid any conflict in layer-2 address self-learning, PE nodes 112 and 114 do not learn layer-2 addresses from the packets received via spoke 150.

In some embodiments, PE nodes 112 and 114 operate as layer-2 switches while communicating with CE nodes 111, 113, and 115. CE node 113 exchanges traffic with both partner PE nodes 112 and 114 while communicating with another networking device (e.g., CE node 131). If an active PE node is not selected among partner PE nodes 112 and 114, both PE nodes 112 and 114 forward that traffic to remote PE node 132. PE node 132 thus receives traffic from CE node 113 via two different PE nodes 112 and 114. PE node 132 then considers that CE node 132 is moving between PE nodes 112 and 114. To solve this problem, when standby PE node 114 receives a frame for PE node 132, PE node 114 forwards that frame to active PE node 112 via spoke 150. PE node 150 then forwards the frame to PE node 132. Hence, multi-homed CE node 113 can actively communicate with PE nodes 112 and 114 while only PE node 112 actively communicates with remote PE node 132. In this way, embodiments of the present invention implement multi-chassis trunk 117 with VPLS support. Note that the VPLS instance(s) in PE nodes 112 and 114 is aware of multi-chassis trunk 117. As a result, PE nodes 112 and 114 can distinguish multi-homed CE node 113 from other local CE nodes 111 and 115.

In network site 120, CE node 121 is coupled to PE nodes 122 and 124. However, without a multi-chassis trunk between CE node 121, and PE nodes 122 and 124, CE node 121 blocks traffic exchange with PE node 124 to break the loop and exchanges traffic only with PE node 122. PE odes 122 and 124 can also operate in a master-slave mode. PE node can be the master node and actively communicate with CE node 121. PE node 124 acts as the slave node and only operates when PE node 122 becomes non-operational. To improve performance, a multi-chassis trunk 123 can be established by logically aggregating the links between CE node 121 and PE nodes 122 and 124. After multi-chassis trunk 123 is established, CE node 121 exchanges traffic with both PE nodes 122 and 124. PE nodes 122 and 124 can select PE node 122 as an active node. PE node 124 then becomes a standby node. Multi-chassis trunk 123 then operates like multi-chassis trunk 117.

Because PE node 114 does not forward any traffic to remote PE nodes, PE node 114 can create a control message informing remote PE nodes regarding the standby status of PE node 114. Because of the standby status, PE node 114 does not actively forward traffic to remote PE nodes and provides redundancy to active PE node 112. FIG. 1B illustrates an exemplary virtual private network with redundancy support and a multi-chassis trunk, in accordance with an embodiment of the present invention. Components in FIG. 1B are the same as in FIG. 1A, so the same numerals are used to denote them. During operation, PE node 112 establishes logical connections 152, 162, and 154 with remote PE nodes 122, 124, and 132, respectively. Similarly, PE node 114 establishes logical connections 164, 172, and 166 with remote PE nodes 122, 124, and 132, respectively.

After partner PE nodes 112 and 114 select PE node 112 as the active node, PE node 112 sends a control message indicating the active status of PE node 112 to its remote PE node 122. On the other hand, PE node 114 sends a control message indicating the standby status of PE node 114 to its remote PE node 122. In some embodiments, the control message is a type-length-value (TLV) message. A respective PE node can construct the TLV message based on pseudo-wire redundancy as described in Internet Engineering Task Force (IETF) draft “Pseudowire (PW) Redundancy,” available at http://tools.ietf.org/html/draft-ietf-pwe3-redundancy-03, which is incorporated by reference herein. PE node 122 also sends a control message indicating the active status of PE node 122 to its remote PE node 112. On the other hand, PE node 124 sends a control message indicating the standby status of PE node 124 to its remote PE node 112. As a result, both end points of logical connection 152 are active (can be referred to as an active-active logical connection). However, one end point of logical connection 162 is active while the other end point is standby (can be referred to as an active-standby logical connection).

In the same way, active PE node 112, standby PE node 114, and standby PE node 124 exchange their respective status. Consequently, PE nodes 112, 114, and 124 recognize logical connections 162 and 172 as active-standby and standby-standby connections, respectively. In site 130, PE node 132 may not implement pseudo-wire redundancy. As a result, when PE nodes 112 and 114 send control messages indicating their respective status, PE node 132 does not recognize the messages and considers all remote PE nodes as active. Furthermore, PE node 132 keeps all logical connections active and does not send any status-indicating control message to its remote PE nodes. Because PE nodes 112 and 114 do not receive any status-indicating control message from PE node 132, PE nodes 112 and 114 considers PE node 132 as active. Consequently, PE nodes 112 and 114 consider logical connections 154 and 166 as active-active and active-standby logical connections, respectively.

If standby PE nodes 114 and 124 receive any traffic from a remote PE node, PE nodes 114 and 124 discards the traffic. For example, because PE node 132 does not support pseudo-wire redundancy, PE node 132 does not recognize PE node 114 as a standby node. As a result, PE node 132 forwards traffic via logical connection 166. However, upon receiving, PE node 114 discards this traffic. This unnecessary forwarding leads to bandwidth and resource (e.g., processor and memory operations in PE nodes 132 and 114) wastage in the network. To avoid this unnecessary forwarding, when PE node 112 becomes aware of the standby status of PE node 124, PE node 112 does not forward traffic via logical connection 162. Similarly, when PE node 122 becomes aware of the standby status of PE node 114, PE node 122 does not forward traffic via logical connection 164. In this way, redundancy-supported active PE node 112 and 122 avoid unnecessary forwarding, and save bandwidth and resources.

In some embodiments, a respective logical connection can be identified by a virtual circuit identifier. The partner PE nodes participating in a multi-chassis trunk are configured with the same virtual circuit identifier for a respective VPLS instance. For example, logical connections 152 and 164 can have the same virtual circuit identifier for a VPLS instance. Partner PE nodes 112 and 114 are configured with identical configuration, such as virtual circuit mode and layer-2 forwarding table size. Furthermore, partner PE nodes 112 and 114 are configured with identical set of remote PE nodes. For example, PE nodes 112 and 114 both have PE nodes 122, 124, and 132 as remote PE nodes. PE nodes 112 and 114 establish logical connections 152, 162, 164, and 172 to form a full mesh connectivity with remote site 120. Similarly, PE nodes 112 and 114 also establish logical connections 154 and 155 to form a full mesh connectivity with remote site 130.

### Logical Connection Establishment

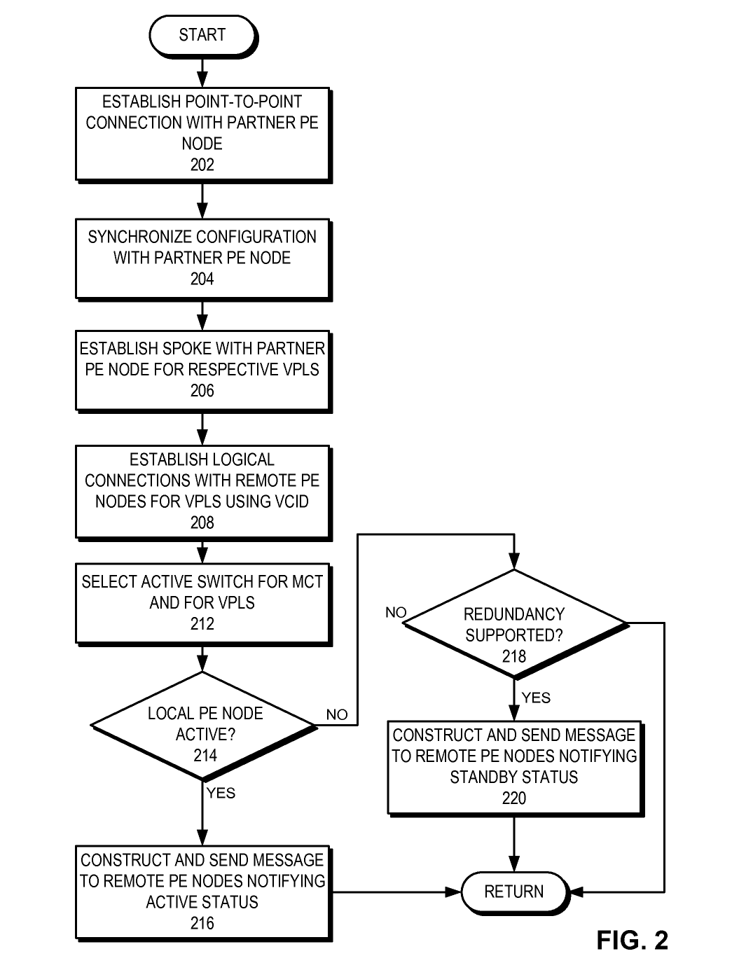

In the example in FIG. 1B, PE nodes 112 and 114 establish spoke 150 between them, and logical connections 152, 154, 162, 164, 166, and 172 with remote sites to exchange data and control traffic. FIG. 2 presents a flowchart illustrating the process of a partner PE node establishing logical connections, in accordance with an embodiment of the present invention. The PE node first establishes a point-to-point connection with a partner PE node (operation 202). The PE node can recognize a partner PE node from local information preconfigured by a network administrator. In some embodiments, the PE node uses CCP to exchange information with the partner PE node. The PE node then synchronizes configuration information with partner PE node (operation 204). Such configuration information can include, but are not limited to, PE node identifier (e.g., an IP address), virtual circuit identifier, virtual circuit mode, and the layer-2 forwarding table size.

The PE node establishes a spoke (i.e., a logical connection) with the partner PE node for a respective VPLS instances (operation 206). For example, if the PE node is operating two VPLS instances corresponding to two VPLS sessions, the PE node establishes two spokes with the partner PE node, wherein a respective spoke is associated with a respective VPLS instance. In some embodiments, the logical connections are MPLS-based VPLS pseudo-wires. The same spoke can be used to support a plurality of multi-homed CE nodes coupled to the same partner PE nodes.

The PE node then establishes logical connections with remote PE nodes based on the synchronized virtual circuit identifier (operation 208). Note that a spoke is created for a VPLS instance separate from other VPLS instances. The PE node selects an active node among the partner PE nodes in conjunction with each other for a respective VPLS instance and for a respective multi-chassis trunk (operation 212). The partner PE nodes can exchange control messages via the spoke to select the active node. The partner PE nodes can use a distributed protocol to select the active node. In some embodiments, the partner PE nodes exchange their respective identifiers with each other and select the PE node with the lowest (or the highest) identifier value as the active node.

The PE node checks whether the local PE node has been elected as the active node (operation 214). If so, the PE node constructs a message indicating the active status of the PE node and sends the message to its remote PE nodes via the established logical connections (operation 216). In some embodiments, the message is constructed based on VPLS pseudo-wire redundancy. If the local PE node has not been elected as the active node (i.e., has been elected as a standby node), the PE node checks whether redundancy is supported by the PE node (operation 218). If supported, the PE node constructs a message indicating the standby status of the PE node and sends the message to its remote PE nodes via the established logical connections (operation 220).

### Layer-2 Address Learning

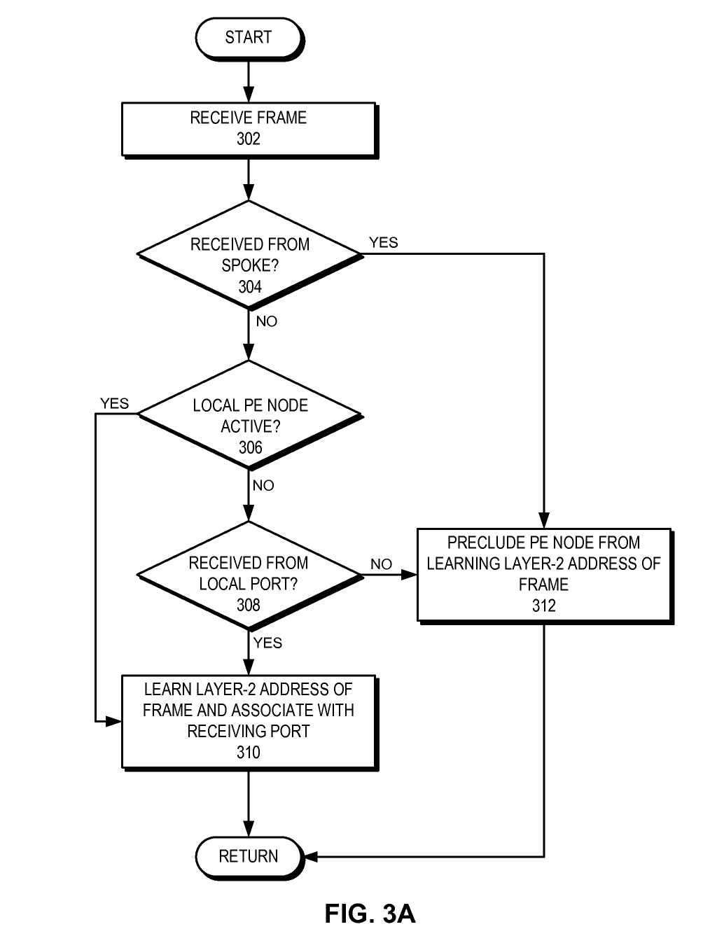

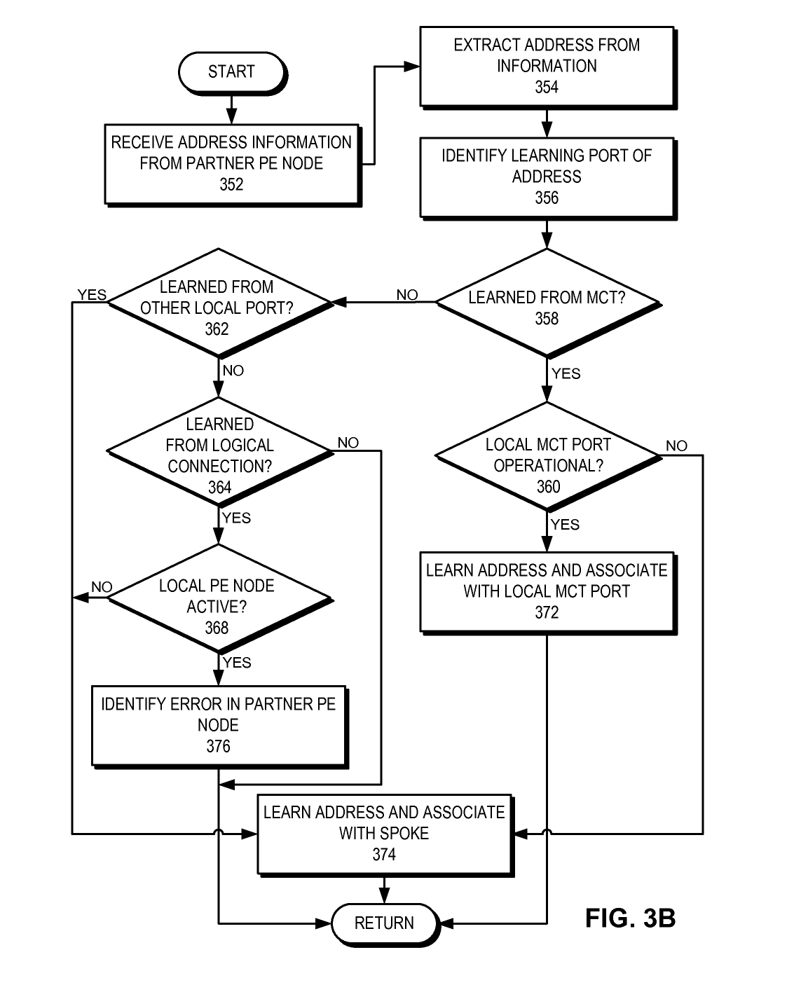

A PE node may receive a frame via a local port, the spoke, or a logical connection. Depending on how the PE node receives the frame, the PE node may learn and associate the layer-2 address of the frame. In some embodiments, the layer-2 address is a Media Access Control (MAC) address. FIG. 3A presents a flowchart illustrating the process of a PE node learning the layer-2 address of a received frame, in accordance with an embodiment of the present invention. Upon receiving a frame (operation 302), the PE node checks whether the frame is received from a spoke (operation 304). If not, the PE node checks whether the local PE node is an active node (operation 306). If the frame is not received from the spoke (operation 304) and the PE node is not an active node (operation 306), the PE node checks whether frame is received from a local port (operation 308). If the PE node is an active node (operation 306) or the frame is received from a local port (operation 308), the PE node learns the layer-2 address of the frame and associates the address with the receiving port (operation 310). However, if the frame is received from the spoke (operation 304) or the frame is not received from a local port (operation 308), the PE node precludes the PE node from learning the layer-2 address of the frame (operation 312).

A PE node can also learn a layer-2 from a partner PE node participating in a multi-chassis trunk. FIG. 3B presents a flowchart illustrating the process of a PE node learning layer-2 addresses from a partner PE node, in accordance with an embodiment of the present invention. The PE node receives address information from a partner PE node (operation 352). The PE node can extract the address information from a received frame from the partner PE node. Such address information can include one or more layer-2 (e.g., MAC) address. The PE node extracts an address from the received address information (operation 354) and identifies the port from which the partner PE node has learned the address (operation 356).

The PE node then checks whether the partner PE node has learned the address from one of the ports participating in the multi-chassis trunk (operation 358). If the address is not learned from the multi-chassis trunk, the PE node checks whether the partner PE node has learned the address from one of the other local ports of the partner PE node (operation 362). If the address is not learned from a local port of the partner PE node, the PE node checks whether the partner PE node has learned the address from one of its logical connections (operation 364). Note that a PE node does not learn an address from a spoke. If the address is learned from a logical connection of the partner PE node, the PE node checks whether the local PE node is the active node for the multi-chassis trunk (operation 368). If the local PE node is the active node (i.e., the partner PE node is a standby node), the PE node identifies that an error has been occurred in the partner PE node (operation 376) because a standby PE node does not learn an address from a logical connection. If the address is not learned from a logical connection of the partner PE node, the PE node does not learn the address.

If the address is learned from the multi-chassis trunk (operation 358), the PE node checks whether the local port participating in the multi-chassis trunk is operational (operation 360). If the local port is operational, the PE node learns the address and associates the address with the local port participating in the multi-chassis trunk (operation 372). Note that even if the address is learned from a port of the partner PE node, the PE node associates the address with a local port because both the ports participate in the same multi-chassis trunk. If the address is learned from a local port of the partner PE node (operation 362) or the local port participating in the multi-chassis trunk is not operational (operation 360), the PE node learns the address and associates the address with the spoke which couples the PE node to the partner PE node (operation 374).

### Forwarding Process

A PE node participating in a multi-chassis trunk forwards a frame based on the type of the frame (e.g., unicast, multicast, or broadcast) and how the frame has been received by the PE node (e.g., from a local port, spoke, or logical connection). Note that a local port can be a port participating in the multi-chassis trunk or a regular port coupling a CE node. FIG. 4A presents a flowchart illustrating the process of a partner PE node forwarding a unicast data frame, in accordance with an embodiment of the present invention. Upon receiving a unicast frame (operation 402), the PE node checks whether the local PE node is the active node for the multi-chassis trunk (operation 404). If the PE node is the active node, the PE node checks whether the destination of the frame is coupled to a partner PE node (operation 412). The PE node is aware of the CE nodes coupled to the partner PE node because the partner PE nodes share their learned addresses, as described in conjunction with FIG. 3B.

If the destination of the frame is not coupled to the partner PE node, the PE node checks whether the frame is for a remote PE node (operation 414). If the destination of the frame is not coupled to the partner PE node (operation 412) and the frame is for a remote PE node (operation 414), the PE node forwards the frame to the remote PE via the corresponding logical connection (operation 416). If the PE node is not the active node, the PE node checks whether the frame is received from a local port (operation 422). If the frame is not received from a local port, the PE node checks whether the frame is received from a spoke (operation 424). If the frame is not received from a local port (operation 422) and the frame is not received from spoke (operation 424), the PE node discards the frame (operation 426) because the frame is received from a remote PE node.

If the PE node is a standby node (operation 404) and the frame is received from a local port (operation 422), or if the PE node is an active node (operation 404) and the destination of the frame is coupled to the partner PE node (operation 412), the PE node identifies the corresponding partner PE node (operation 432). The PE node then forwards the frame to the partner PE node (operation 434). If the frame is not for a remote PE node (operation 414) or if the frame is received from a spoke (operation 424), the PE node checks whether the frame is for a local CE node (operation 436). If the frame is for a local CE node, the PE node forwards the frame via the local port which couples the CE node to the PE node (operation 438). If the frame is not for a local CE node, the PE node discards the frame (operation 426).

FIG. 4B presents a flowchart illustrating the process of a partner PE node forwarding a multi-destination frame, in accordance with an embodiment of the present invention. A multi-destination frame is a frame which the PE node forwards via multiple ports. Examples of a multi-destination frame include, but are not limited to, an unknown unicast frame, a broadcast frame, or a multicast frame. Upon receiving a multi-destination frame (operation 452), the PE node checks whether the local PE node is the active node for the multi-chassis trunk (operation 454). If the PE node is an active node, the PE node checks whether the frame is received from a local port (operation 460). If the frame is received from a local port, the PE node forwards the frame via the logical connections, other local ports, and spoke(s) coupling the partner PE node(s) (operation 462).

If the frame is not received from a local port, the PE node checks whether the frame is received from a logical connection coupling a remote PE node (operation 464). If the frame is received from a logical connection, the PE node forwards the frame via the local ports and the spoke(s) (operation 466). If the frame is not received from a logical connection, the PE node checks whether the frame is received from a spoke (operation 468). If the frame is received from a spoke (i.e., from a partner PE node), the PE node forwards the frame via the logical connections, local ports, and other spokes to other PE nodes (operation 470).

If the PE node is not an active node (i.e., a standby node) (operation 454), the PE node checks whether the frame is received from a local port (operation 480). If the frame is received from a local port, the PE node forwards the frame via the other local ports and the spoke coupling the active PE node (operation 482). If the frame is not received from a local port, the PE node checks whether the frame is received from a logical connection coupling a remote PE node (operation 484). The PE node can receive frame from a remote PE node because the remote PE node may not support pseudo-wire redundancy and recognize the PE node as a standby node. If the frame is received from a logical connection, the PE node discards the frame (operation 486). If the frame is not received from a logical connection, the PE node checks whether the frame is received from a spoke (operation 488). If the frame is received from a spoke, the PE node forwards the frame via the local ports (operation 490).

### Failure Recovery

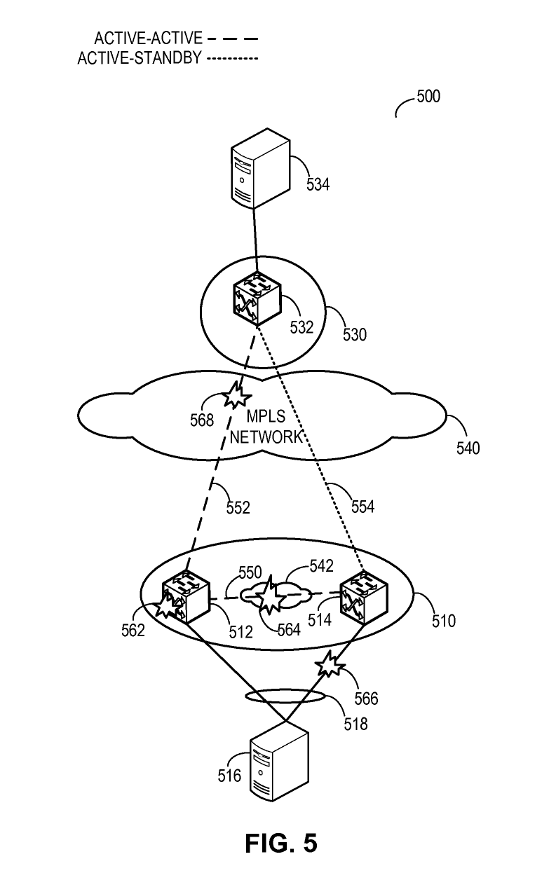

During operation, a PE node can incur a link or a node failure. FIG. 5 illustrates exemplary failure scenarios in a virtual private network with a multi-chassis trunk, in accordance with an embodiment of the present invention. A virtual private network 500 includes network sites 510 and 530, interconnected via network 540. In some embodiments, network 540 is an MPLS network. Site 510 includes PE nodes 512 and 514. Multi-homed CE node 516 is coupled to partner PE nodes 512 and 514 via multi-chassis trunk 518. PE nodes 512 and 514 can be coupled to each other via one or more physical links. PE nodes 512 and 514 create a separate network 542 and interconnect each other via spoke 550. In some embodiments, spoke 550 is a MPLS-based VPLS pseudo-wire. Partner PE nodes 512 and 514 select PE node 512 as the active node and PE node 514 as a standby node. Site 530 includes CE node 534 coupled to node 532 via one or more physical links. PE node 512 establishes active-active logical connections 552 and PE node 514 establishes active-standby logical connection 554 with remote PE node 532, respectively.

Suppose that failure 562 fails active PE node 512 and partner PE node 514 detects the failure. In some embodiments, partner PE nodes 512 and 514 exchange periodic control message via spoke 550 to notify each other regarding the respective operational states. If PE node 514 does not receive any control message from PE node 512 for a period of time, PE node 514 detects a failure to PE node 512. Upon detecting the failure of the active PE node 512, standby PE node 514 starts operating as the active node and forwards the traffic received from CE node 516 to remote PE node 532.

Suppose that failure 564 fails spoke 550. When spoke 550 fails, the corresponding VPLS instance cannot support the multi-chassis trunk. PE nodes 512 and 514 both become an active node. In some embodiments, if the links coupling CE node 516 to PE nodes 512 and 514 remain active, PE nodes 512 and 514 initiate a master-slave selection process for the corresponding VPLS instance. In a master-slave mode of operation, the master node actively forwards traffic while the slave nodes remain inactive. If PE node 514 is selected as the master node, PE node 514 creates and sends a notification message to CE node 516 indicating its master status. PE node 512 becomes inactive. In some embodiments, PE node 512 can go to a sleep mode. As a result, only PE node 514 receives traffic from CE node 516 and forwards the traffic to remote PE node 532.

Suppose that failure 566 fails the link between PE node 514 and CE node 516. Consequently, the multi-chassis trunk 518 fails as well. PE nodes 512 and 514 both become active and start forwarding traffic from locally coupled CE nodes. In this example, PE node 512 forwards traffic from CE node 516. Suppose that failure 568 fails active-active logical link 552. Because logical link 552 is an MPLS connection, an MPLS failure recovery process is triggered.

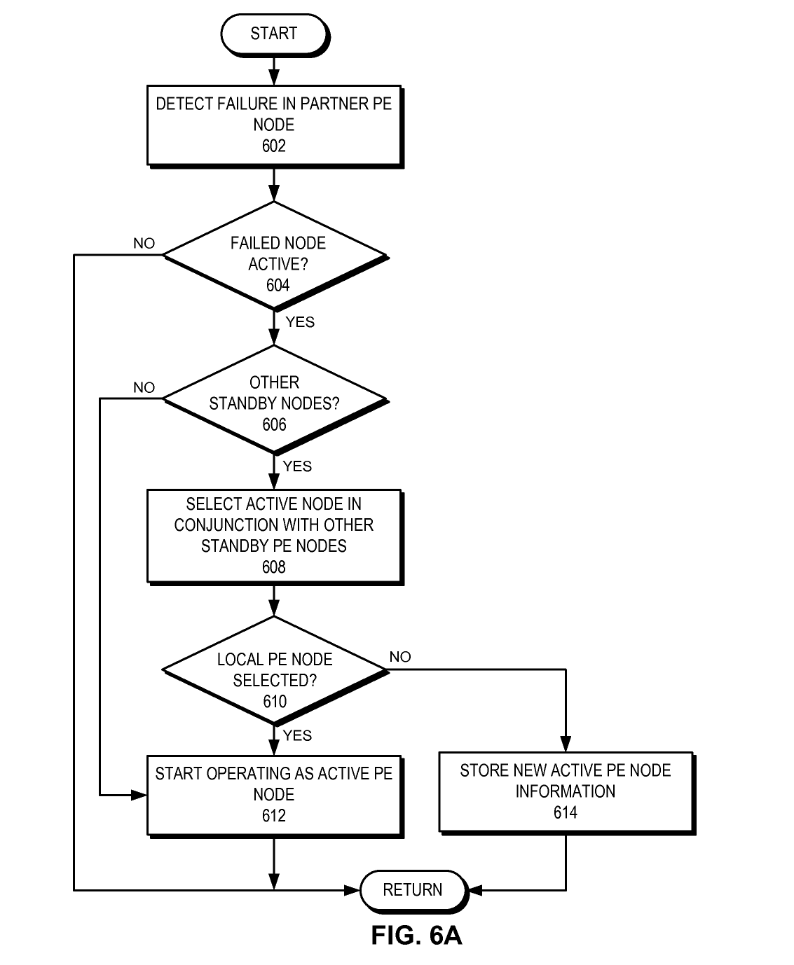

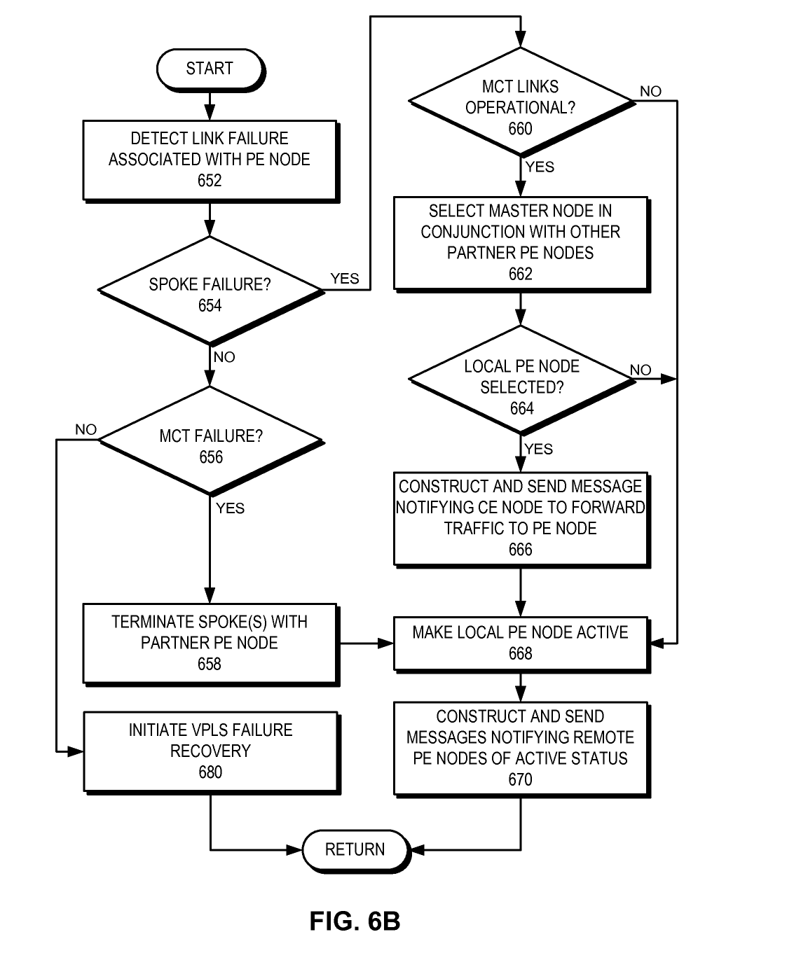

FIG. 6A presents a flowchart illustrating the recovery process of a partner PE node from a partner node failure, in accordance with an embodiment of the present invention. Upon detecting a failure to a partner PE node (operation 602), the PE node checks whether the failed node has been the active node (operation 604). In some embodiments, the PE node detects a failure by not receiving a control message for a predetermined period of time. If the failed node has been the active node, the PE node checks whether any other standby PE nodes are available (operation 606). A respective partner PE node can remain aware of all other operational PE nodes by exchanging control messages.

If other standby PE nodes are available, the PE node selects an active PE node in conjunction with other standby PE nodes (operation 608), as described in conjunction with FIG. 1A. The PE node then checks whether the local PE node is selected as the active node (operation 610). If no other standby PE node is available (operation 606) or the local PE node is selected as the active node (operation 610), the PE node starts operating as the active PE node (operation 612). If the local PE node is not selected as the active node, the PE node stores the new active PE node information (operation 614).

FIG. 6B presents a flowchart illustrating the recovery process of a partner PE node from a link failure, in accordance with an embodiment of the present invention. Upon detecting the link failure (operation 652), the PE node checks whether the failure is a spoke failure (operation 654). If a spoke has failed, the PE node checks whether the links participating the multi-chassis trunk is operational (operation 660). If the links are operational, the PE node selects an master node in conjunction with other partner PE nodes (operation 662). The PE node then checks whether the local PE node is selected as the master node (operation 664). If the local node is selected as the master node, the PE node constructs and sends a message notifying the CE node associated with the multi-chassis trunk regarding the master status of the PE node (operation 666).

If a spoke has not failed, the PE node checks whether a link participating in the multi-chassis trunk has failed (operation 656). If not, the MPLS recovery process is initiated (operation 680). Otherwise, the PE node terminates the spoke(s) with partner PE nodes (operation 658). If one or more links of the multi-chassis trunk are not operational (operation 660), the local PE node has constructed and sent a notification message to the CE node (operation 666), or the PE node has terminated the spoke(s) (operation 658), the PE node becomes an active PE node for the corresponding VPLS instance (operation 668). Note that an active PE node forwards traffic via its logical connections. The PE node then constructs and sends messages notifying the remote PE nodes regarding the active status of the PE node (operation 670).

### Exemplary Switch System

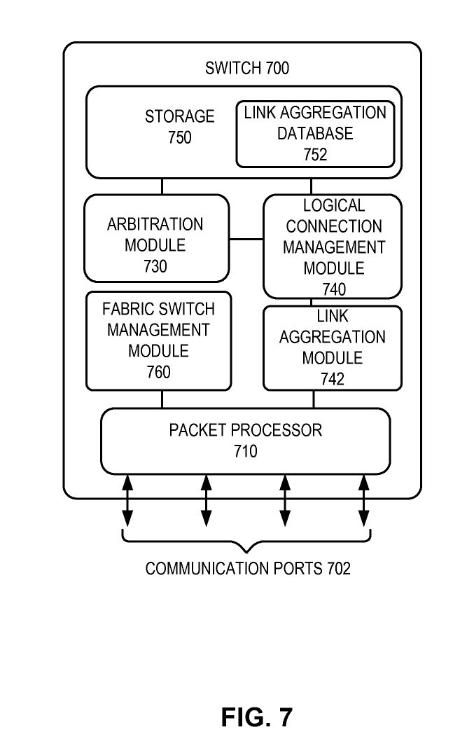

FIG. 7 illustrates an exemplary switch, in accordance with an embodiment of the present invention. In this example, a switch 700 includes a number of communication ports 702, an arbitration module 730, a packet processor 710, a logical connection management module 740, a link aggregation module 742, and a storage 750. Storage 750 stores a link aggregation database 752. Link aggregation module 472 enables switch 700 to join a multi-chassis trunk in conjunction with other switches. At least one of the communication ports 702 participate in the multi-chassis trunk. Packet processor 710 extracts and processes header information from the received frames via communication ports 702.

In some embodiments, switch 700 may maintain a membership in a fabric switch, wherein switch 700 also includes a fabric switch management module 760. Fabric switch management module 760 maintains a configuration database in storage 750 that maintains the configuration state of every switch within the fabric switch. Fabric switch management module 760 maintains the state of the fabric switch, which is used to join other switches. In some embodiments, switch 700 can be configured to operate in conjunction with a remote switch as a logical Ethernet switch. Under such a scenario, communication interfaces 702 can include inter-switch communication channels for communication within a fabric switch. This inter-switch communication channel can be implemented via a regular communication port and based on any open or proprietary format. Communication interfaces 702 can include one or more TRILL interfaces capable of receiving frames encapsulated in a TRILL header. Packet processor 710 can process these frames.

Link aggregation database 752 stores information regarding the partner switches participating in the multi-chassis trunk. Link aggregation module 742 obtains information regarding the partner switches of the multi-chassis trunk. Arbitration module 730 initiates an active switch selection process and uses the information in link aggregation database 752 to select a switch from the partner switches as the active switch. If arbitration module 730 selects switch 700 as the active switch, packet processor 710 constructs packets forwardable via a logical connection for remote switches in remote sites. Packet processor 710 also constructs a control packet for the remote switches indicating that switch 700 has been selected as the active switch. The logical connection can be a pseudo-wire associated with a VPLS instance. The pseudo-wire can be an MPLS connection and represent a logical link in a virtual private network. If switch 700 implements a VPLS instance, switch 700 operates as a PE node and forwards traffic via logical connections using one or more of the communication ports 702. Switch 700 can also exchange traffic with one or more CE nodes via one or more of the communication ports 702.

Logical connection management module 740 operates in conjunction with packet processor 710, and constructs and sends an instruction message to a second partner switch. Based on the instruction message, logical connection management module 740 establishes a logical connection to the second partner switch. This logical connection is referred to as a spoke and associated with a VPLS instance separate from the VPLS instances of the other logical connections to the remote switches. Logical connection management module 740 precludes switch 700 from learning a layer-2 address of any packet received from the spoke to avoid any conflict in self-learning of layer-2 addresses. In some embodiments, this self-learning is MAC address learning.

If arbitration module 730 selects switch 700 as a standby switch, packet processor 710 constructs a control packet for the remote switch indicating that switch 700 has been selected as a standby switch. Arbitration module 730 then precludes packet processor 710 from constructing any other packet for the remote switch. In other words, packet processor 710 does not forward any packet via the logical connections to the remote switch. When switch 700 receives any frame from a CE node coupled to switch via one of the communication ports 702, packet processor 710 encapsulates the frame in a packet forwardable via a logical connection (i.e., in an MPLS frame format) and forwards the packet to the active switch via the spoke. If switch 700 receives any packet via a logical connection from a remote switch, packet processor 710 discards the frame. When switch 700 receives any packet from a partner switch, packet processor 710 extracts the content of the packet. Examples of such content include, but are not limited to, layer-2 addresses learned by a partner switch, a data frame, and configuration information of the partner switch.

Note that the above-mentioned modules can be implemented in hardware as well as in software. In one embodiment, these modules can be embodied in computer-executable instructions stored in a memory which is coupled to one or more processors in switch 700. When executed, these instructions cause the processor(s) to perform the aforementioned functions.

In summary, embodiments of the present invention provide a switch and a method for VPLS support over a multi-chassis trunk. The switch includes a link aggregation database, an arbitration module, a packet processor, and a logical connection management module. The link aggregation database stores information regarding a plurality of switches participating in a multi-chassis trunk. The plurality of switches includes the switch as well. The arbitration module selects a switch of the plurality of switches as an active switch based on the information in the link aggregation database. The packet processor constructs a packet for a remote switch forwardable via a logical connection. The logical connection management module operates in conjunction with the packet processor and constructs a message containing instructions for creating a second logical connection to a second switch of the plurality of switches.

The methods and processes described herein can be embodied as code and/or data, which can be stored in a computer-readable non-transitory storage medium. When a computer system reads and executes the code and/or data stored on the computer-readable non-transitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A switch, comprising:
a link aggregation database configurable to store information regarding a plurality of switches participating in a multi-chassis trunk, wherein the plurality of switches include the switch;
an arbitration module configurable to select a switch of the plurality of switches as an active switch based on the information in the link aggregation database;
an packet processor configurable to construct a packet for a remote switch, wherein the packet is forwardable via a logical connection; and
a logical connection management module operable in conjunction with the packet processor and configurable to construct a message containing instructions for creating a second logical connection to a second switch of the plurality of switches.

2. The switch of claim 1, wherein a respective logical connection is a pseudo-wire associated with a virtual private local area network (LAN) service (VPLS) instance, wherein the pseudo-wire represents a logical link in a virtual private network (VPN).

3. The switch of claim 2, wherein the pseudo-wire is a Multiprotocol Label Switching (MPLS) connection.

4. The switch of claim 2, wherein the logical connection management module is further configurable to associate the second logical connection with a second VPLS instance.

5. The switch of claim 1, wherein the logical connection management module is further configurable to preclude the switch from learning a layer-2 address of a packet received from the second logical connection.

6. The switch of claim 1, wherein the packet for the remote switch includes information indicating whether the switch is the active switch.

7. The switch of claim 1, wherein the arbitration module is further configurable to:
select the switch as a standby switch in response to selecting the second switch as the active switch; and
preclude the packet processor from constructing a packet for the remote switch, wherein the packet is forwardable via a logical connection.

8. The switch of claim 7, wherein the packet processor is further configurable to construct a packet encapsulating a frame received from a local port, wherein the packet is for the second switch and forwardable via the second logical connection.

9. The switch of claim 7, the packet processor is further configurable to discard a packet received from the remote switch, wherein the packet is forwardable via a logical connection; and
wherein the logical connection management module is further configurable to preclude the switch from learning a layer-2 address of the packet.

10. The switch of claim 7, wherein the packet processor is further configurable to extract from a packet one or more layer-2 addresses learned by the second switch.

11. A computer-executable method, comprising:
storing in a link aggregation database, by a computer, information regarding a plurality of switches participating in a multi-chassis trunk;
selecting a switch of the plurality of switches as an active switch based on the information in the link aggregation database;
constructing a packet for a remote switch, wherein the packet is forwardable via a logical connection; and
constructing a message containing instructions for creating a second logical connection to a second switch of the plurality of switches.

12. The method of claim 11, wherein a respective logical connection is a pseudo-wire associated with a virtual private local area network (LAN) service (VPLS) instance, wherein the pseudo-wire represents a logical link in a virtual private network (VPN).

13. The method of claim 12, wherein the pseudo-wire is a Multiprotocol Label Switching (MPLS) connection.

14. The method of claim 12, further comprising associating the second logical connection with a second VPLS instance.

15. The method of claim 11, precluding the computer from learning a layer-2 address of a packet received from the second logical connection.

16. The method of claim 11, wherein the packet for the remote switch includes information indicating whether a switch in the plurality of switches is the active switch.

17. The method of claim 11, further comprising:
selecting a switch in the plurality of switches as a standby switch in response to selecting the second switch as the active switch; and
precluding the switch from constructing a packet for the remote switch, wherein the packet is forwardable via a logical connection.

18. The method of claim 17, further comprising constructing a packet encapsulating a frame received from a local port of the switch, wherein the packet is for the second switch and forwardable via the second logical connection.

19. The method of claim 17, further comprising:
discarding a packet received from the remote switch, wherein the packet is forwardable via a logical connection; and
precluding the switch from learning a layer-2 address of the packet.

20. The method of claim 17, further comprising extracting from a packet one or more layer-2 addresses learned by the second switch.
